(19) United States
(12) Patent Application Publication
(10) Pub. No.: US 2024/0302805 A1
(43) Pub. Date: Sep. 12, 2024

(54) CONTROL DEVICE, CONTROL METHOD, AND RECORDING MEDIUM

(71) Applicant: NEC CORPORATION, Tokyo (JP)

(72) Inventors: Shumpei Kubosawa, Tokyo (JP); Takashi Onishi, Tokyo (JP)

(73) Assignee: NEC Corporation, Minato, Tokyo (JP)

(21) Appl. No.: 18/273,220

(22) PCT Filed: Mar. 30, 2021
(86) PCT No.: PCT/JP2021/013640

§ 371 Date: Jul. 19, 2023

(51) Int. Cl. G05B 13/04

(52) U.S. Cl. CPC G05B 13/041

(57) ABSTRACT

A control device calculates, by simulation of a control target, information indicating a trend of response of the control target. The control device calculates, based on the information indicating the trend of the response of the control target, an input value to the control target in order to bring an output value of the control target closer to an envisaged value.

### TECHNICAL FIELD

This invention relates to a control device, a control method, and a recording medium.

### BACKGROUND ART

In some cases, it is effective to use a simulator to determine the control method of a plant or other control target.

For example, the operation assistance system described in Patent Document 1 learns the operation content of operations on a system to be operated, such as the valve opening degree to inject a certain amount of a given liquid. During this learning of the operation content, the quantitative response of the system to the amount of operation may be calculated using a simulator.

### PRIOR ART DOCUMENTS

### Patent Documents

Patent Document 1: PCT International Publication No. WO2020/054164

### SUMMARY OF THE INVENTION

### Problems to be Solved by the Invention

It is conceivable that a change in the state of a control target may result in a failure to obtain the envisaged value of the output even if the planned input value, such as the operation plan value of the control target, is input to the control target. In this case, it is desirable to be able to bring the output value of the control target closer to the envisaged value without the need to analyze the state of the control target.

One of the objects of the present invention is to provide a control device, a control method, and a recording medium that can solve the above-mentioned issue.

### Means for Solving the Problem

According to the first example aspect of the invention, a control device includes: a response trend calculation means that calculates, by simulation of a control target, information indicating a trend of response of the control target; and an input value calculation means that calculates, based on the information indicating the trend of the response of the control target, an input value to the control target in order to bring an output value of the control target closer to an envisaged value.

According to the second example aspect of the present invention, in a control method, a computer calculates, by simulation of a control target, information indicating a trend of response of the control target, and calculates, based on the information indicating the trend of the response of the control target, an input value to the control target in order to bring an output value of the control target closer to an envisaged value.

According to the third example aspect of the present invention, a recording medium is a recording medium that records a program for causing a computer to execute calculating, by simulation of a control target, information indicating a trend of the response of the control target; and calculating, based on the information indicating the trend of the response of the control target, an input value to the control target in order to bring an output value of the control target closer to an envisaged value.

### Effect of Invention

According to the aforementioned control device, control method, and recording medium, the output value of a control target can be brought closer to an envisaged value without the need to analyze the state of the control target.

### BRIEF DESCRIPTION OF THE DRAWINGS

FIG. 1 is a diagram illustrating an example configuration of the control system according to the first example embodiment.

FIG. 2 is diagram illustrating an example of the slope calculated by the response trend calculation unit according to the first example embodiment.

FIG. 3 is a flowchart illustrating an example of the processing procedure in which the control device according to the first example embodiment controls an actual machine of the control target.

FIG. 4 is a diagram illustrating an example of the history of output values of the control target according to the first example embodiment.

FIG. 5 is a diagram illustrating an example configuration of the control system according to the second example embodiment.

FIG. 6 is a diagram illustrating an example of data flow during operation of the control device according to the second example embodiment.

FIG. 7 is a diagram illustrating an example of data flow during the learning process of the control device according to the second example embodiment.

FIG. 8 is a flowchart illustrating an example of the processing procedure performed during operation of the control device according to the second example embodiment.

FIG. 9 is a flowchart illustrating an example of the processing procedure performed during the learning process of the control device according to the second example embodiment.

FIG. 10 is a diagram illustrating an example configuration of the control device according to the third example embodiment.

FIG. 11 is a flowchart showing an example of the processing procedure in the control method for the fourth example embodiment.

FIG. 12 is a schematic block diagram illustrating the configuration of a computer according to at least one example embodiment.

### EXAMPLE EMBODIMENT

The following is a description of example embodiments of the invention, but the following example embodiments do not limit the scope of the claimed invention. All of the combinations of features described in the example embodiments may not be essential to the solution means of the invention.

### First Example Embodiment

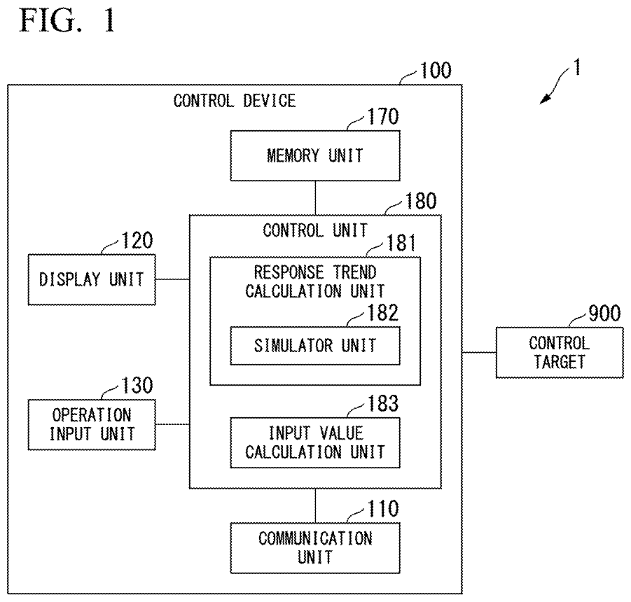

FIG. 1 shows a configuration example of the control system according to the first example embodiment. In the configuration shown in FIG. 1, a control system 1 includes a control device 100 and a control target 900. The control device 100 includes a communication unit 110, a display unit 120, an operation input unit 130, a storage unit 170, and a control unit 180. The control unit 180 includes a response trend calculation unit 181 and an input value calculation unit 183. The response trend calculation unit 181 includes a simulator unit 182.

The control target 900 can be a variety of things capable of executing simulations and is not limited to any particular one. For example, the control target 900 may be, but is not limited to, a chemical plant. The control target 900 may be a system that includes multiple devices, a single device, or a portion of a device.

The control target 900 may be a distillation tower, and the control device 100 may be used to control the heating by the reboiler of the distillation tower.

The control target 900 may be a railroad system, and the control device 100 may provide the scheduled arrival and departure times of trains. For example, if a train operation plan has been established that indicates the scheduled departure and arrival times of trains, and trains has arrived later than the scheduled times, the control device 100 may provide an estimated time of departure and arrival to mitigate the time delay.

The control commands that the control device 100 sends to the control target 900 shall include quantitative information, for example, valve opening degree Command values. The quantitative information contained in the control commands that the control device 100 sends to the control target 900 is also referred to as input values to the control target 900. When there are multiple input values to the control target 900, the individual inputs are also referred to as input items, and the individual input values are also referred to as input item values.

The data that the control target 900 transmits to the control device 100 shall include quantitative information, for example, temperature, flow rate, and valve opening measurements. The quantitative information contained in the data that the control target 900 transmits to the control device 100 is also referred to as the output value of the control target 900. When there are multiple output values of the control target 900, the individual outputs are also referred to as output items, and the individual output values are also referred to as output item values.

The control device 100 controls the control target 900. The control device 100 is composed of, for example, a computer.

The communication unit 110 communicates with other devices. For example, the communication unit 110 receives sensor data and other data from the control target 900. The communication unit 110 also transmits control commands to the control target 900.

The display unit 120 has a display screen, such as a liquid crystal panel or LED (light emitting diode) panel, for example, and displays various images. For example, the display unit 120 may display control commands to the control target 900 and data from the control target 900.

The operation input unit 130 includes input devices such as a keyboard and mouse, for example, and receives user operations. For example, the operation input unit 130 may receive either one or both of the user operation that instructs the start of control over the control target 900 and the user operation that instructs the end of control over the control target 900.

The storage unit 170 stores various types of data. For example, the storage unit 170 may store historical information of the input values to the control target 900 and historical information on the output values of the control target 900. The storage unit 170 is configured using a storage device that the control device 100 includes.

The control unit 180 controls each unit of the control device 100 to perform various processes. The functions of the control unit 180 are executed, for example, by the CPU (central processing unit) included in the control device 100 reading and executing a program from the storage unit 170.

The response trend calculation unit 181 calculates information indicating the trend in the response of the control target 900 by simulating the control target 900. The response trend calculation unit 181 may calculate the ratio of the change in the output value of the simulator to the change in the input value of the control target 900 to the simulator.

The response trend calculation unit 181 corresponds to an example of a response trend calculation means.

When it is desired to ascertain the response of the control target 900, it may not be desirable from the standpoint of stable operation of the actual machine to observe the response by varying the input value to the actual machine. In contrast, by changing the input values to the simulator of the control target 900, it is possible to ascertain the response without affecting the operation of the actual machine.

In this case, it is not necessary for the output values to match exactly if the response trends are similar between the actual machine of the control target 900 and the simulator of the control target 900. For example, if the amount of change in the output value when the input value is changed by a predetermined amount is similar between the actual machine and the simulator, the output values themselves need not be the same.

The simulator unit 182 performs simulations of the control target 900. The simulator unit 182 corresponds to an example of a simulator of the control target 900. The simulator unit 182 may be configured as a separate device from the control device 100.

The control target 900 is referred to as the actual machine of the control target 900 or simply the actual machine. A simulator of the control target 900 is also referred to simply as a simulator.

The input value calculation unit 183 calculates, on the basis of the information indicating a trend of the response of the control target 900, an input value to the control target 900 in order to bring the output value of the control target 900 closer to the envisaged value. The envisaged value here may be the value envisaged as the output of the control target 900 in the operation plan of the control target 900. The response trend calculation unit 181 may calculate the envisaged value during operation of the actual machine. Alternatively, the envisaged values may be obtained in advance.

For example, the input value calculation unit 183 may calculate the input value to the control target 900 on the basis of the difference between the output value of the control target 900 and the envisaged value, and the ratio calculated by the response trend calculation unit 181. For the data of the response characteristics of the simulator used to calculate this ratio, the response trend calculation unit 181 may measure the response characteristics of the simulator during operation of the actual machine. Alternatively, data on the response characteristics of the simulator may be obtained in advance.

The input value calculation unit 183 corresponds to an example of an input value calculation means.

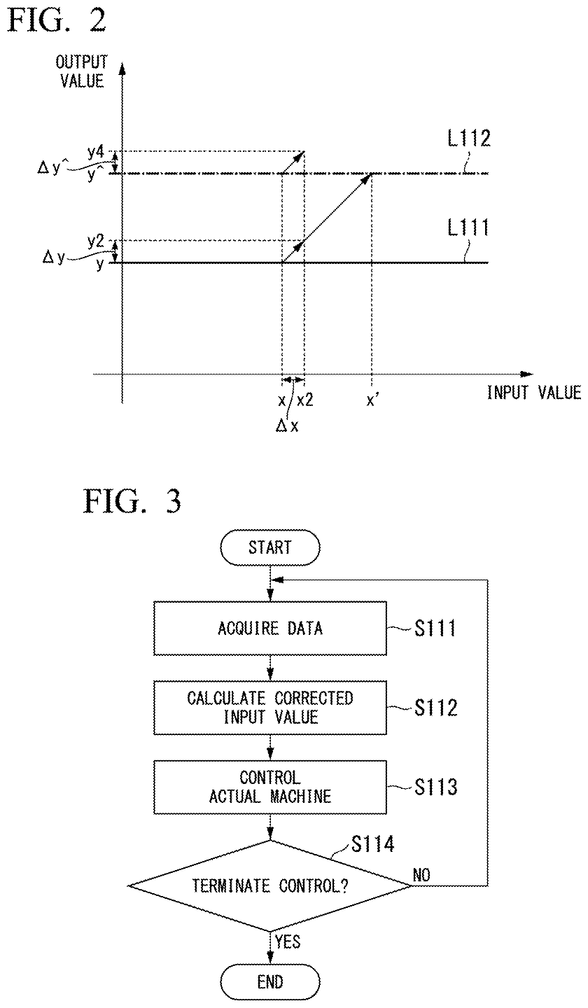

FIG. 2 shows an example of the slope calculated by the response trend calculation unit 181. The horizontal axis of the graph in FIG. 2 shows the input values to the control target 900. The vertical axis indicates the output values of the control target 900. FIG. 2 shows an example where there is one input item to the control target 900 and one output item from the control target 900.

In the example in FIG. 2, the input value to the actual machine of the control target 900 is represented by x, and the output value of the actual machine with respect to the input value x is represented by y. Line L111 shows the output value y of the actual machine. If the input value to the actual machine is x2, the output value is y2.

The difference obtained by subtracting x from x2 is denoted as Δx. Δx=x2−x. Similarly, the difference obtained by subtracting y from y2 is denoted as Δy. Δy=y2−y.

The same input value x is also input to the simulator of the control target 900 as in the case of the actual machine. On the other hand, the output value of the simulator with respect to the input value x is y\hat{ }. Line L112 represents the output value of the simulator. If the input value to the simulator is x2, the output value is y4.

The difference obtained by subtracting y\hat{ } from y4 is denoted as Δy\hat{ }. Δy\hat{ }=y4−y\hat{ }.

Now consider the case where the output value of the simulator is the envisaged value of the output of the control target 900, and it is desired to bring the output value of the actual machine close to the output value of the simulator. To bring close here includes matching. In other words, the output value of the actual machine may be made to match the output value of the simulator.

An example of a case in which the output value of the actual machine of the control target 900 is brought closer to the output value of the simulator is when the operation plan of the actual machine is formulated using the simulator of the control target 900. When the control device 100 inputs the input values indicated in the operation plan to the actual machine, the output values of the actual machine may differ from the output values in the operation plan, and it may be desired to bring the output values of the actual machine closer to the output values in the operation plan.

In the example shown in FIG. 2, the control device 100 compensates the input values to the actual machine to bring the output values of the actual machine closer to the output values of the simulator. The control device 100 corrects the input values to the actual machine in such a way that the output values of the actual machine match the envisaged values or come as close as possible if an exact match is not achievable.

As a precondition for the control device 100 to calculate the correction value of the input to the actual machine, it is assumed that the trend of the change in the output value of the simulator with respect to the change in the input value to the simulator is the same as the trend of the change in the output value of the actual machine with respect to the change in the input value to the actual machine.

In the example of FIG. 2, the correspondence between the increase or decrease of input values and the increase, decrease, or no change of output values is consistent between the actual machine and the simulator. If the input value increases, the output value increases in both the actual machine and the simulator. If the input value decreases, the output value decreases in both the actual machine and the simulator.

Furthermore, in the example in FIG. 2, the ratio of the amount of increase or decrease in input values to the amount of increase or decrease in output values is consistent between the actual machine and the simulator. If the input value increases by Δx, the output value of the actual machine increases by Δy, and the output value of the simulator increases by Δy\hat{ }, thus Δy=Δy\hat{ }.

Moreover, in the example in FIG. 2, input values and output values have a linear relationship in both the actual machine and the simulator. Contrary to the above case of increase, if the input value decreases by Δx, the output value of the actual machine decreases by Δy, and the output value of the simulator decreases by Δy\hat{ }, thus Δy=Δy\hat{ }.

In the control device 100, the response trend calculation unit 181 uses the simulator by the simulator unit 182 to calculate the ratio of the amount of change in the output value of the control target 900 to the amount of change in the input value to the control target 900. This ratio corresponds to an example of information indicating a trend in the response of the control target 900.

The response trend calculation unit 181 changes the input value to the simulator from x to x₂, and after the output value of the simulator stabilizes, reads the simulator output value y4. Thereby, the response trend calculation unit 181 calculates the ratio of the amount of change in the output value of the control target 900 to the amount of change in the input value to the control target 900 as Δy\hat{ }/Δx.

The input value calculation unit 183 calculates the corrected input value based on the ratio Δy\hat{ }/Δx calculated by the response trend calculation unit 181. In the example shown in FIG. 2, the corrected input value is represented by x′.

Due to the fact that Δy=Δy\hat{ } and the linearity between the input and output values in the actual machine of the control target 900, the relationship in Expression (1) holds true.

$$\begin{matrix}[ Expression 1 ] & \\ \frac{Δ y \hat{}}{Δ x} = \frac{y \hat{} - y}{{x}^{′} - x} & ( 1 )\end{matrix}$$

Expression (1) can be transformed to obtain Expression (2).

$$\begin{matrix}[ Expression 2 ] & \\ {x}^{′} = x + \frac{y \hat{} - y}{dy \hat{}} Δ x & ( 2 )\end{matrix}$$

The input value calculation unit 183 calculates the corrected input value x′ based on Expression (2).

dy\hat{ } denotes the amount of analytical minute change in the differential calculation. In actual calculations, dy\hat{ } can be approximated by Δy\hat{ }. Specifically, the response trend calculation unit 181 can calculate the derivative of y\hat{ } using a difference approximation.

FIG. 3 is a flowchart illustrating an example of a processing procedure in which the control device 100 controls the actual machine of the control target 900.

In the process shown in FIG. 3, the control unit 180 acquires the data necessary to correct the input value (Step S111). For example, the control unit 180 acquires the input value x to the actual machine of the control target 900 and the simulator, the output value y of the actual machine with respect to the input value x, the envisaged value y\hat{ } of the output value, and the ratio Δy\hat{ }/Δx between the change in input value Δx and the change in output value Δy.

As described above, for the envisaged output value y\hat{ }, the output value output in real time by the simulator unit 182 operating as an online simulator may be used by the control unit 180 as the envisaged value y\hat{ }. Alternatively, a predetermined envisaged value y\hat{ } may be stored by the storage unit 170, and the control unit 180 may read it from the storage unit 170.

As described above, for the ratio Δy\hat{ }/Δx, a value calculated in advance by the response trend calculation unit 181 using the simulator unit 182 may be stored by the storage unit 170 and read from the storage unit 170 by the control unit 180. Alternatively, the response trend calculation unit 181 may calculate the ratio Δy\hat{ }/Δx in Step S111.

Note that in Expression (2), the reciprocal of the ratio Δy\hat{ }/Δx is expressed in the form Δx/dy\hat{ }. Accordingly, the response trend calculation unit 181 may calculate the reciprocal of the ratio Δy\hat{ }/Δx, namely Δx/Δy\hat{ }.

Next, the input value calculation unit 183 calculates the corrected input value x′ (Step S112). For example, the input value calculation unit 183 calculates the corrected input value x′ based on the above Expression (2).

Next, the control unit 180 controls the actual machine by transmitting the corrected input value x′ to the actual machine of the control target 900 via the communication unit 110 (Step S113).

Next, the control unit 180 determines whether or not to terminate control of the actual machine of the control target 900 (Step S114). For example, the control unit 180 may determine to terminate control of the actual machine when control of the actual machine based on the operation plan has been completely performed, i.e., when control of the actual machine has been performed for the number of time steps in the operation plan.

If the control unit 180 makes determination to continue control of the actual machine (Step S114: NO), the process returns to Step S111. In this case, the control device 100 continues to control the control target 900 by repeating the processing in FIG. 3.

On the other hand, if the control unit 180 determines to end the control of the actual machine (Step S114: YES), the control device 100 terminates the processing in FIG. 3.

If there are multiple input items to the control target 900, the control device 100 may correct the input values to the control target 900 for each input item.

In this case, the response trend calculation unit 181 may calculate the ratio of the change in the output value of the simulator of the control target 900 to the change in the input value for each input item to the control target 900. The input value calculation unit 183 may then calculate the input value to the control target 900 on the basis of the difference between the output value of the control target 900 and its envisaged value and the ratio calculated by the response trend calculation unit 181.

When the number of input items to the control target 900 is two, the relationship between the change in the input value and the change in the output value can be expressed as in Expression (3).

$$[ Expression 3 ]$$

$$Δ y \hat{}= \frac{\partial f ( {x}_{1} , {x}_{2} )}{\partial {x}_{1}} Δ {x}_{1} + \frac{\partial f ( {x}_{1} , {x}_{2} )}{\partial {x}_{2}} Δ {x}_{2} \qquad ( 3 )$$

f is a function that represents the simulation model of the control target 900. The function f takes the values of the two input variables x1 and x2 as input, and outputs the output value as the function value f(x₁, x₂).

In Expression (3), the total derivative of the function f (x₁, x₂) is approximated by the partial derivative of each input variable, and the change in the output value of the simulator, Δy\hat{ }, is calculated by multiplying each slope indicated by the partial derivative by the change in the input variables, Δx₁ and Δx₂.

Expression (4) shows the corrected input value x′ to bring the output value y of the actual machine closer to the envisaged value y\hat{ } by comparing the change in the output value of the simulator, Δy\hat{ }, shown in Expression (3) and the difference y\hat{ }-y obtained by subtracting the output value y of the actual machine from the envisaged value y\hat{ } of the output value.

$$[ Expression 4 ]$$

$${x}^{′} = x + \frac{y \hat{} - y}{Δ y \hat{}} [ Δ {x}_{1} , Δ {x}_{2} ] = x + \frac{y \hat{} - y}{Δ y \hat{}} Δ x \qquad ( 4 )$$

In Expression (4), x represents a vector and x=[x₁, x₂]. Here, the input values to the control target 900 are represented by “x₁” and “x₂”, the same as the input variable names above. In addition, x′ represents a vector and x′=[x₁′, x₂′]. x₁′ represents the corrected input value after correcting the input value x₁. x₂′ indicates the corrected input value after correcting the input value x₂.

If the vector [Δx₁, Δx₂] is generalized and denoted as Δx, Expression (4) is generalized to “x′=x+((y\hat{ }−y)/Δy\hat{ })Δx” as shown on the left-hand side and right-hand side. This expression also applies when the number of input items to the control target 900 is three or more.

The input value calculation unit 183 may calculate the corrected input value x′ based on Expression (4).

If there are multiple input items to the control target 900 and multiple output items from the control target 900, the control device 100 may preliminarily calculate the input values to the control target 900 for each output item and then average the provisional input values with weighted averaging according to the output items.

In this case, the response trend calculation unit 181 may calculate the ratio of the change in the output value of the simulator of the control target 900 to the change in the input value for each input item to the control target 900 and for each output item of the control target 900. The input value calculation unit 183 may then calculate a provisional input value for each output item based on the difference between the output value of the control target 900 and its envisaged value and the ratio calculated by the response trend calculation unit 181, and then calculate the input value to the control target based on the provisional input value.

For the case where the number of input items to the control target 900 is two and the number of output items is also two, the two input items shall be represented by the input variables x₁ and x₂, and the two output items shall be represented by the output variables y₁\hat{ } and y₂\hat{ }. In this case, the relationship between changes in the values of the input variables x₁ and x₂, Δx₁ and Δx₂, and changes in the value of output variables y₁\hat{ }, namely Δy₁\hat{ }, can be expressed as in Expression (5).

$$[ Expression 5 ]$$

$$Δ {y}_{1}^{\hat{}} = \frac{\partial {y}_{1}^{\hat{}}}{\partial {x}_{1}} Δ {x}_{1} + \frac{\partial {y}_{1}^{\hat{}}}{\partial {x}_{2}} Δ {x}_{2} \qquad ( 5 )$$

In Expression (5), the total derivative of variable y₁\hat{ } is approximated by the partial derivative of each input variable, and the change in the output value of the simulator, Δy₁\hat{ }, is calculated by multiplying each of the slopes indicated by the respective partial derivative by the change in the input variables, Δx₁ and Δx₂.

Similarly, the relationship between the change in the value of input variables x₁ and x₂, namely Δx₁ and Δx₂, and the change in the value of output variable y₂\hat{ }, namely Δy₂\hat{ }, can be expressed as in Expression (6).

$$[ Expression 6 ]$$

$$Δ {y}_{2}^{\hat{}} = \frac{\partial {y}_{2}^{\hat{}}}{\partial {x}_{1}} Δ {x}_{1} + \frac{\partial {y}_{2}^{\hat{}}}{\partial {x}_{2}} Δ {x}_{2} \qquad ( 6 )$$

Expression (7) shows the corrected input value x₁′ to bring the output value y\hat{ } of the actual machine closer to the envisaged value y₁\hat{ }, when comparing the change in the output value of the simulator, Δy₁\hat{ }, shown in Expression (5), with the difference y₁\hat{ }−y₁ obtained by subtracting the output value y1 of the actual machine from the envisaged output value y₁\hat{ }.

$$[ Expression 7 ]$$

$${x}_{y 1}^{′} = x + \frac{{y}_{1}^{\hat{}} - {y}_{1}}{{dy}_{1}^{\hat{}}} [ Δ {x}_{1} , Δ {x}_{2} ] = x + \frac{{y}_{1}^{\hat{}} - {y}_{1}}{Δ {y}_{1}^{\hat{}}} Δ x \qquad ( 7 )$$

As in Expression (2), dy\hat{ }denotes the amount of analytical minute change in the differential calculation. In actual calculations, dy\hat{ }can be approximated by Δy\hat{ }. Specifically, the response trend calculation unit 181 can calculate the derivative of y\hat{ } using a difference approximation.

In Expression (7), x represents a vector and x=[x₁, x₂]. Here, the input values to the control target 900 are represented by “x₁” and “x₂”, the same as the input variable names above. x_{y1}′ represents a vector and x_{y1}′=[x_{1, y1}′, x_{2, y1}′]. x_{1, y1}′ represents the input value after correcting the input value x₁ so that the output value y\hat{ }approaches the envisaged value y₁\hat{ }. x_{2,y1}′ represents the input value after correcting the input value x₂, so that the output value y₁\hat{ } approaches the envisaged value y₁\hat{ }.

If the vector [Δx₁, Δx₂] is generalized and denoted as Δx, Expression (7) is generalized to “x_{y1}′=x+((y₁\hat{ }−y₁)/Δy₁\hat{ })Δx” as shown on the left-hand side and right-hand side. This expression also applies when the number of input items to the control target 900 is three or more.

Expression (8) shows the corrected input value x₂′ to bring the output value y2 of the actual machine closer to the envisaged value y₂\hat{ }, when comparing the change in the output value of the simulator, Δy₂\hat{ }, shown in Expression (6), with the difference y₂\hat{ }−y₂ obtained by subtracting the output value y2 of the actual machine from the envisaged output value y₂\hat{ }.

$$[ Expression 8 ]$$

$${x}_{y 2}^{′} = x + \frac{{y}_{2}^{\hat{}} - {y}_{2}}{{dy}_{2}^{\hat{}}} [ Δ {x}_{1} , Δ {x}_{2} ] = x + \frac{{y}_{2}^{\hat{}} - {y}_{2}}{Δ {y}_{2}^{\hat{}}} Δ x \qquad ( 8 )$$

As in expressions (2) and (7), dy\hat{ } denotes the amount of analytical minute change in the differential calculation. In actual calculations, dy\hat{ } can be approximated by Δy\hat{ }. Specifically, the response trend calculation unit 181 can calculate the derivative of y\hat{ } using a difference approximation.

As in Expression (7), in Expression (8), x represents a vector and x=[x₁, x₂]. Here, the input values to the control target 900 are represented by “x₁” and “x₂”, the same as the input variable names above. x_{y2}′ represents a vector and x_{y2}′=[x_{1, y2}′, x_{2, y2}′]. x_{1, y2}′ represents the input value after correcting the input value x₁ so that the output value y₂ approaches the envisaged value y₂\hat{ }. x_{2, y2}′ represents the input value after correcting the input value x₂ so that the output value y₂ approaches the envisaged value y₂\hat{ }.

If the vector [Δx₁, Δx₂] is generalized and denoted as Δx, Expression (8) is generalized to “x_{y2}′=x+((y₂\hat{ }−y₂)/Δy₂\hat{ })Δx” as shown on the left-hand side and right-hand side. This expression also applies when the number of input items to the control target 900 is three or more.

The input value calculation unit 183 may weight average the corrected input values for each output item shown in Expressions (7) and (8) using weighting coefficients determined for each output item. The weighted average in this case is shown in Expression (9).

$$[ Expression 9 ]$$

$${x}^{′} = x + {\sum }_{i} ( {c}_{i} \frac{{y}_{i}^{\hat{}} - {y}_{i}}{Δ {y}_{i}^{\hat{}}} ) Δ x \qquad ( 9 )$$

i is an identification number that identifies the output item.

In Expression (9), x represents a vector and x=[x₁, x₂, . . . ]. Here, the input value for each input item to the control target 900 is represented by xⱼ, where j is an identification number used to identify the input item.
x′ represents a vector, where x′=[x₁′, x₂′, . . . ]. xⱼ′ represents the corrected input value xⱼ after correction.
Δx represents a vector and Δx=[Δx₁, Δx₂, . . . ]. Δxⱼ indicates the amount of change in the input value xⱼ.
cᵢ is a weighting coefficient set for each output item. The larger the value of ci, the closer the output value yᵢ of that output item is to the envisaged value yᵢ\hat{ }. The value of cᵢ is also called the matching degree requirement.

By setting the sum of cᵢ to be 1, as shown in Expression (10), Expression (9) becomes the formula for weighted averaging.

$$[ Expression 10 ]$$

$${\sum }_{i} {c}_{i} = 1 \qquad ( 10 )$$

Note that good results were obtained through the correction of input values in experiments conducted under the conditions where the number of input items was one and the number of output items was one, and time-varying noise was mixed in with respect to the input command values.

If the correction to the input value to the control target 900 described above still results in a difference between the output value and the envisaged value, the input value calculation unit 183 may also perform a conversion on the correction value for further correction.

For example, the response trend calculation unit 181 calculates the ratio of the change in the output value of the simulator to the change in the input value to the simulator of the control target 900. The input value calculation unit 183 converts the ratio calculated by the response trend calculation unit 181 based on the difference between the output value of the actual machine of the control target 900 and its envisaged value and the difference between the output value of the control target 900 and its envisaged value. The response trend calculation unit 181 uses the converted value to calculate the input value to the control target 900.

Here, time is expressed in time steps. The input value calculation unit 183 may calculate the input value xₜ₊₁′ to the actual machine of the control target 900 at time t+1 based on Expression (11).

$$[ Expression 11 ]$$

$${x}_{t + 1}^{′} = {x}_{t + 1} + ( {y}_{t}^{\hat{}} - {y}_{t} ) ( w \frac{Δ {x}_{t}}{Δ {y}_{t}} + b ) \qquad ( 11 )$$

xₜ₊₁ indicates the input value before correction at time t+1.
yₜ\hat{ } represents the envisaged value of the output of the control target 900 at time t.
yₜ indicates the output value of the actual machine of the control target 900 at time t.
Δxₜ indicates the amount of change in the input value to the control target 900. Δyₜ indicates the amount of change in the output value of the control target 900. Δxₜ/Δyₜ is the reciprocal of the differential approximation Δyₜ/Δxₜ of the value at x=xₜ of the derivative df(x)/dx of the function f(x), which indicates the input-output relationship of the control target 900.

The response trend calculation unit 181 may calculate yₜ\hat{ }+Δyₜ=f(xₜ+Δxₜ) using the simulation model of the simulator unit 182 as the function f. As Δxₜ, a small positive constant value can be used, such as the value defined as the smallest unit of change in the input value x.

The response trend calculation unit 181 may then calculate Δxₜ/Δyₜ=((xₜ+Δxₜ)−xₜ)/((yₜ\hat{ }+Δyₜ\hat{ })−yₜ\hat{ }).

Both w and b are parameters whose values are updated at each time. In this context, “at each time” here is each step in a time step. w at time t can also be denoted as wₜ. b at time t is also denoted bₜ.

The initial value of parameter w is set to 1. The initial value of parameter b is set to 0.

Comparing Expression (11) with Expression (2), in Expression (2), the input value calculation unit 183 calculates the correction value (y\hat{ }−y)Δx/Δy to be added to the input value x by multiplying y\hat{ }−y by dx/dy or Δx/Δy.

On the other hand, in Expression (11), the input value calculation unit 183 does not directly multiply y\hat{ }−yₜ by Δxₜ/Δyₜ, but calculates wₜ₊₁Δx/Δyₜ+bₜ₊₁, which is obtained by correcting Δxt/Δyt by a linear function. The input value calculation unit 183 uses this wₜ₊₁(Δxₜ/Δyₜ)+bₜ₊₁ to calculate the correction value (yₜ\hat{ }−yₜ) (wₜ₊₁ Δxₜ/Δyₜ+bₜ₊₁) to be added to the input value xₜ₊₁.

The input value calculation unit 183 may use the gradient descent method to learn the value of w and the value of b. For example, the input value calculation unit 183 learns the value of w and the value of b so that the loss function value eₜ₊₁² shown in Expression (12) is smaller for the correction using Expression (11) at time t+1.

$$[ Expression 12 ]$$

$${e}_{t + 1}^{2} = {( {y}_{t + 1}^{\hat{}} - {y}_{t + 1} )}^{2} = {( {y}_{t + 1}^{\hat{}} - f ( {x}_{t + 1}^{′} ) )}^{2} \qquad ( 12 )$$

For example, the input value calculation unit 183 calculates the values of w and b that minimize the loss function value eₜ₊₁² and uses them for the correction shown in Expression (11).

The expression for updating parameter values is shown, for example, in Expression (13).

$$[ Expression 13 ]$$

$$w ← w - η \frac{\partial e ( w , b )}{\partial w} , b ← b - η \frac{\partial e ( w , b )}{\partial b} \qquad ( 13 )$$

η is a constant indicating the learning rate, where 0<η≤1.
e(w, b) is the error eₜ₊₁=y_{t+1\hat{ }}−f(xₜ₊₁′) shown in Expression (12) expressed as a function of w and b.
∂(w, b)∂w in Expression (13) can be transformed as in Expression (14).

$$[ Expression 14 ]$$

$$\begin{matrix}\frac{\partial e ( w , b )}{\partial w} = \frac{\partial }{\partial w} {( {y}_{t + 1}^{\hat{}} - f ( {x}_{t + 1}^{′} ) )}^{2} \\ = \frac{\partial }{\partial w} ( {( {y}_{t + 1}^{\hat{}} )}^{2} + {f}^{2} ( {x}_{t + 1}^{′} ) - 2 {y}_{t + 1}^{\hat{}} f ( {x}_{t + 1}^{′} ) ) \\ = \frac{\partial }{\partial w} ( {f}^{2} ( {x}_{t + 1}^{′} ) - 2 {y}_{t + 1}^{\hat{}} f ( {x}_{t + 1}^{′} ) ) \\ = \frac{\partial }{\partial w} {f}^{2} ( {x}_{t + 1}^{′} ) - 2 {y}_{t + 1}^{\hat{}} \frac{\partial }{\partial w} f ( {x}_{t + 1}^{′} ) \\ = \frac{\partial {f}^{2} ( {x}_{t + 1}^{′} )}{\partial f ( {x}_{t + 1}^{′} )} \frac{\partial f ( {x}_{t + 1}^{′} )}{\partial {x}_{t + 1}^{′}} \frac{\partial {x}_{t + 1}^{′}}{\partial w} - 2 {y}_{t + 1}^{\hat{}} \frac{\partial f ( {x}_{t + 1}^{′} )}{\partial {x}_{t + 1}^{′}} \frac{\partial {x}_{t + 1}^{′}}{\partial w} \\ = ( 2 f ( {x}_{t + 1}^{′} ) - 2 {y}_{t + 1}^{\hat{}} ) \frac{\partial f ( {x}_{t + 1}^{′} )}{\partial {x}_{t + 1}^{′}} \frac{\partial {x}_{t + 1}^{′}}{\partial w} \\ = 2 ( {y}_{t + 1} - {y}_{t + 1}^{\hat{}} ) \frac{\partial f ( {x}_{t + 1}^{′} )}{\partial {x}_{t + 1}^{′}} ( {y}_{t}^{\hat{}} - {y}_{t} ) \frac{Δ {x}_{t}}{Δ {y}_{t}}\end{matrix} \qquad ( 14 )$$

Furthermore, ∂(w, b)/∂w can be transformed as in Expression (15).

$$[ Expression 15 ]$$

$$\begin{matrix}\frac{\partial e ( w , b )}{\partial w} = 2 ( {y}_{t + 1} - {y}_{t + 1}^{\hat{}} ) \frac{\partial f ( {x}_{t + 1}^{′} )}{\partial {x}_{t + 1}^{′}} ( {y}_{t}^{\hat{}} - {y}_{t} ) \frac{Δ {x}_{t}}{Δ {y}_{t}} \\ ≃ 2 ( {y}_{t + 1} - {y}_{t + 1}^{\hat{}} ) \frac{Δ {y}_{t + 1}}{Δ {x}_{t + 1}} ( {y}_{t}^{\hat{}} - {y}_{t} ) \frac{Δ {x}_{t}}{Δ {y}_{t}} \\ ≃ 2 ( {y}_{t + 1} - {y}_{t + 1}^{\hat{}} ) \frac{Δ {y}_{t}}{Δ {x}_{t}} ( {y}_{t}^{\hat{}} - {y}_{t} ) \frac{Δ {x}_{t}}{Δ {y}_{t}} \\ = - 2 {e}_{t + 1} {e}_{t}\end{matrix} \qquad ( 15 )$$

In the transformation from the first line to the second line in Expression (15), the partial derivative “∂f(xₜ₊₁′)/∂xₜ₊₁′” is difference approximated by “Δyₜ₊₁/Δxₜ₊₁”. In the transformation from the second line to the third line, “Δyₜ₊₁/Δxₜ₊₁” is approximated by “Δyₜ/Δxₜ” at the one previous time.

In addition, ∂(w, b)/∂b in Expression (13) can be transformed as in Expression (16).

$$[ Expression 16 ]$$

$$\begin{matrix}\frac{\partial e ( w , b )}{\partial w} = \frac{\partial }{\partial b} {( {y}_{t + 1}^{\hat{}} - f ( {x}_{t + 1}^{′} ) )}^{2} \\ = 2 ( {y}_{t + 1} - {y}_{t + 1}^{\hat{}} ) \frac{\partial f ( {x}_{t + 1}^{′} )}{\partial {x}_{t + 1}^{′}} ( {y}_{t}^{\hat{}} - {y}_{t} ) \\ ≃ 2 ( {y}_{t + 1} - {y}_{t + 1}^{\hat{}} ) \frac{Δ {y}_{t + 1}}{Δ {x}_{t + 1}} ( {y}_{t}^{\hat{}} - {y}_{t} ) \\ ≃ 2 ( {y}_{t + 1} - {y}_{t + 1}^{\hat{}} ) \frac{Δ {y}_{t}}{Δ {x}_{t}} ( {y}_{t}^{\hat{}} - {y}_{t} ) \\ = - 2 {e}_{t + 1} {e}_{t} {d}^{- 1}\end{matrix} \qquad ( 16 )$$

d=Δx/Δy. In Expression (16), d=Δxₜ/Δyₜ.

The transformation from the first line to the second line of Expression (16) is the same as in Expression (14). Note that “Δxt/Δyt” is multiplied on the right-hand side of the first line of Expression (15), whereas “Δxt/Δyt” is not multiplied in the second line of Expression (16). This is because in the calculation of “∂xₜ₊₁′/∂w” in the sixth line of Expression (14), the w term is “(yₜ\hat{ }−yₜ)wΔxₜ/Δyₜ” when the right-hand side of Expression (11) is expanded, whereas the b term is “(yₜ\hat{ }−yₜ)b”.

In the transformation from the second line to the third line in Expression (16), the partial derivative “∂f(xₜ₊₁′)/∂xₜ₊₁′” is difference approximated by “Δyₜ₊₁/Δxₜ₊₁”. In the transformation from the third line to the fourth line, “Δyₜ₊₁/Δxₜ₊₁” is approximated by “Δyt/Δxt” at one previous time.

Based on Expressions (15) and (16), Expression (13) can be transformed as in Equation (17).

$$[ Equation 17 ]$$

$$w ← w + 2 η {e}_{t + 1} {e}_{t} , b ← b + 2 η {e}_{t + 1} {e}_{t} {d}^{- 1} \qquad ( 17 )$$

The input value calculation unit 183 may use the loss function shown in Expression (12) and the update expression shown in Expression (17) to learn the values of w and b. The input value calculation unit 183 may update the value of w and the value of b at each time of the time step through learning.

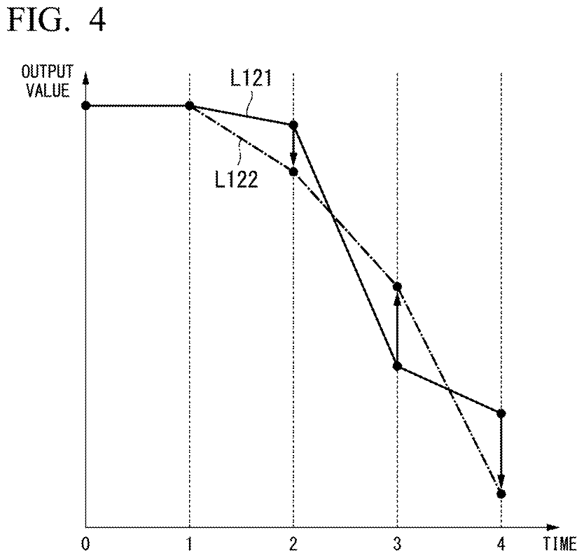

FIG. 4 is a graph showing an example of the history of the output values of the control target 900. The horizontal axis of the graph in FIG. 4 shows time as index 0, 1, 2, . . . in time steps. The vertical axis shows the output values of the control target 900.

Line L121 shows the output value of the actual machine. Line L121 shows the envisaged value of the output.

At time t=0, the initial value of the output of the control target 900 is shown. In the initial state, the output value y₀ of the actual machine and the envisaged value y₀\hat{ } by the simulator match. The values of parameters w and b are initially set to w=1 and b=0.

At time t=1, the input value calculation unit 183 performs the first calculation of the input value to the actual machine of the control target 900. In the process at time t=1, the input value calculation unit 183 calculates the input value x₁′=x₁, since y₀\hat{ }−y₀=0 in Expression (11). Therefore, the input value calculation unit 183 transmits the input value x₁ indicated as the planned value to the control target 900 via the communication unit 110 without correction.

At time t=2, the input value calculation unit 183 performs the second calculation of the input value to the actual machine of the control target 900. In the process at time t=2, the input value calculation unit 183 calculates the input value x₂′=x₂, since y₁\hat{ }−y₁=0 in Expression (11). Therefore, the input value calculation unit 183 transmits the input value x₂ indicated as the planned value to the control target 900 via the communication unit 110 without correction.

At time t=3, the input value calculation unit 183 performs the third calculation of the input value to the actual machine of the control target 900. In the process at time t=3, the input value calculation unit 183 calculates x₃′=x₃+(y₂\hat{ }−y₂)(wΔx₂/Δy₂+b) based on Expression (11).

At the beginning of the process at time t=3, w=1 and b=0, and the input value calculation unit 183 calculates the initial value of x₃′ as x₃′=x₃+(y₂\hat{ }−y₂)Δx₂/Δ_{y2}.

Then, the input value computation unit 183 calculates the values of w and b that minimize the loss function value e₃²=(y₃\hat{ }−f(x₃′))² of Expression (12) using the update expressions w←w+2η(y₃\hat{ }−f(x₃′))(y₂\hat{ }−y₂) and b←w+2η(y₃\hat{ }−f(x₃′))(y₂\hat{ }−y₂)Δx₂/Δy₂ of Expression (17).

The input value calculation unit 183 calculates the corrected input value x₃′ based on the calculated values of w and b, and transmits it to the control target 900 via the communication unit 110.

The input value calculation unit 183 stores the calculated values of w and b in the storage unit 170 as w₃ and b₃.

At time t=4, the input value calculation unit 183 performs the fourth calculation of the input value to the actual machine of the control target 900. In the process at time t=4, the input value calculation unit 183 calculates x₄′=x₄+(y₃\hat{ }−y₃) (wΔx₃/Δy₃+b) based on Expression (11).

At the beginning of the process at time t=4, w=w₃ and b=b₃, and the input value calculation unit 183 calculates the initial value of x₄′ as x₄′=x₄+(y₃\hat{ }−y₃) (w₃Δx₃/Δy₃+b₃).

Then, the input value computation unit 183 calculates the values of w and b that minimize the loss function value e₄²=(y₄\hat{ }−f(x₄′))² of Expression (12) using the update expressions w←w+2η(y₄\hat{ }−f(x₄′)(y₃\hat{ }−y₃) and b←w+2η(y₄\hat{ }−f(x₄′)(y₃\hat{ }−y₃)Δx₃/Δy₃ of Expression (17).

The input value calculation unit 183 calculates the corrected input value x₄′ based on the calculated values of w and b, and transmits it to the control target 900 via communication unit 110.

The input value calculation unit 183 stores the calculated values of w and b in the storage unit 170 as w₄ and b₄.

By learning a conversion method for the ratio of the amount of change in the output value relative to the amount of change in the input value to the control target 900, the input calculation unit 183 is expected to bring the output value further closer to the target value. In particular, the learning performed by the input value calculation unit 183 allows the observed trend with respect to the difference between the output value of the control target 900 and its envisaged value to be reflected in the correction to the input value. According to the input value calculation unit 183, it is expected that the input values can be corrected with high precision in this respect, bringing the output values closer to the expected values.

As described above, the response trend calculation unit 181 calculates information indicating the trend of the response of the control target 900 by simulating the control target 900. The input value calculation unit 183 calculates, on the basis of the information indicating a trend in the response of the control target 900, an input value to the control target 900 in order to bring the output value of the control target 900 closer to the envisaged value.

According to the control device 100, when the envisaged value of the output cannot be obtained by inputting the predetermined input value to the control target 900, such as when the characteristics of the control target 900 differ between the operation planning phase and the actual operation phase, it is possible to bring the output value of the control target 900 closer to the envisaged value without the need to analyze the state of the control target 900.

In particular, the control device 100 calculates information indicating the trend in the response of the control target 900 through simulation. This allows the control device 100 to ascertain the response trend without affecting the operation of the actual machine of the control target 900.

The response trend calculation unit 181 also calculates the ratio of the change in the output value of the simulator of the control target 900 to the change in the input value to the simulator. The input value calculation unit 183 calculates the input value to the control target 900 based on the difference between the output value of the control target 900 and its envisaged value and the ratio calculated by the response trend calculation unit 181.

According to the control device 100, the input value to the control target 900 can be calculated using the relatively simple calculation that involves calculating the ratio of the change amount in the output value to the conversion amount of the input value. In this respect, it is expected that the load of calculating the input value to the control target 900 by the control device 100 is relatively small, and the calculation of the input value to the control target 900 can be done in a relatively short time.

It is not necessary for the output values to be the same, as long as the response trends are similar between the actual machine and the simulator of the control target 900. For example, if the amount of change in the output value when the input value is changed by a predetermined amount is similar between the actual machine and the simulator, the output values themselves need not be the same. According to the control device 100, the output value can be brought closer to the envisaged value without requiring the accuracy of the simulator in this regard.

The response trend calculation unit 181 also calculates the ratio of the change in the output value of the simulator of the control target 900 to the change in the input value for each input item to the control target 900. The input value calculation unit 183 calculates the input value to the control target 900 based on the difference between the output value of the control target 900 and its envisaged value and the ratio calculated by the response trend calculation unit 181.

According to the control device 100, the output value of the control target 900 can be brought closer to the envisaged value, corresponding to the case where there are multiple input items to the control target 900.

According to the control device 100, the input value to the control target 900 can be calculated for each input item using the relatively simple calculation that involves calculating the ratio of the change amount in the output value to the conversion amount of the input value. In this respect, it is expected that the load of calculating the input value to the control target 900 by the control device 100 is relatively small, and the calculation of the input value to the control target 900 can be done in a relatively short time.

The response trend calculation unit 181 calculates the ratio of the change in the output value of the simulator of the control target 900 to the change in the input value for each input item to the control target 900 and for each output item of the control target 900. The input value calculation unit 183 calculates a provisional input value for each output item based on the difference between the output value of the control target 900 and its envisaged value and the ratio calculated by the response trend calculation unit 181, and calculates the input value to the control target 900 based on the provisional input value.

According to the control device 100, the output value of the control target 900 can be brought closer to the envisaged value, corresponding to the case where there are multiple input and output items to the control target 900, respectively.

According to the control device 100, the input value to the control target 900 can be calculated for each input item and for each output item using the relatively simple calculation that involves calculating the ratio of the change amount in output value to the conversion amount of the input value. In this respect, it is expected that the load of calculating the input value to the control target 900 by the control device 100 is relatively small, and the calculation of the input value to the control target 900 can be done in a relatively short time.

The response trend calculation unit 181 also calculates the ratio of the change in the output value of the simulator of the control target 900 to the change in the input value to the simulator. The input value calculation unit 183 converts the ratio calculated by the response trend calculation unit 181 based on the difference between the output value of the control target 900 and its envisaged value. The input value calculation unit 183 calculates the input value to the control target 900 on the basis of the difference between the output value of the control target 900 and its envisaged value, and the value obtained by converting the ratio.

According to the control device 100, it is expected that the output value of the control target 900 can be brought further closer to the envisaged value. In particular, according to the control device 100, the observed trend with respect to the difference between the output value of the control target 900 and its envisaged value can be reflected in the correction to the input value. According to the control device 100, in this respect it is expected that the input value correction can be performed with high accuracy, resulting in the output value approaching the envisaged value.

### Second Example Embodiment

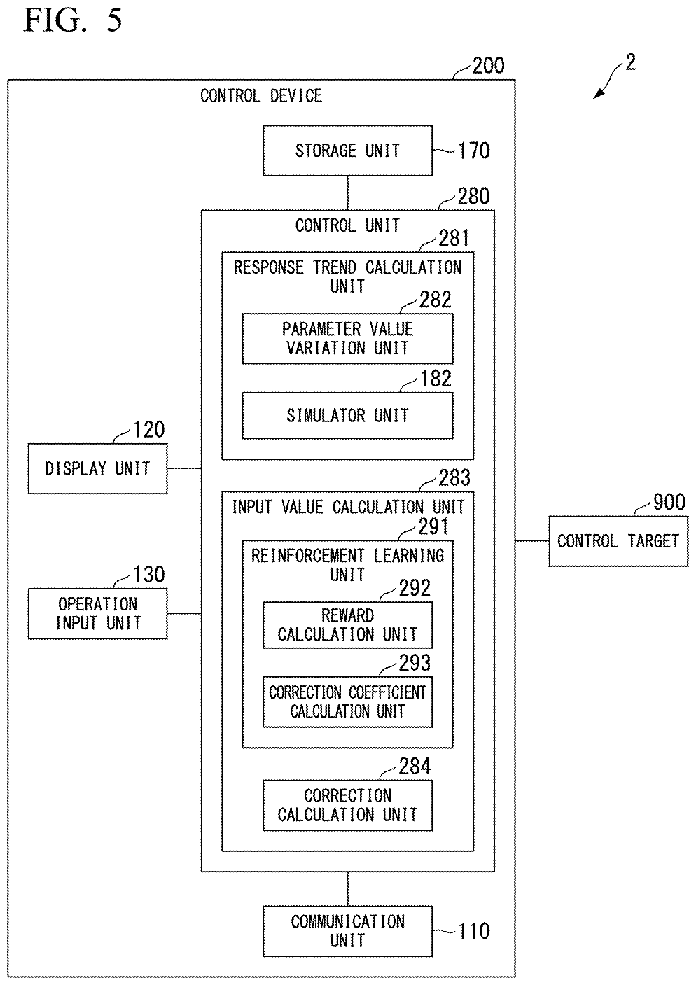

FIG. 5 is a diagram illustrating an example configuration of the control system according to the second example embodiment. In the configuration shown in FIG. 5, a control system 2 includes a control device 200 and a control target 900. The control device 200 has a communication unit 110, a display unit 120, an operation input unit 130, a storage unit 170, and a control unit 280. The control unit 280 includes a response trend calculation unit 281 and an input value calculation unit 283. The response trend calculation unit 281 includes a parameter value variation unit 282 and a simulator unit 182. The input value calculation unit 283 includes a reinforcement learning unit 291 and a correction calculation unit 284. The reinforcement learning unit 291 includes a reward calculation unit 292 and a correction coefficient calculation unit 293.

Among the components shown in FIG. 5, parts that have similar functions to the components in FIG. 1 are labeled with the same reference numerals (110, 120, 130, 170, 182, 900), and detailed explanations are omitted here.

The control device 200 controls the control target 900. The control device 200 is composed using, for example, a computer.

In the control system 2, a combination of time-series data of envisaged values desired to be output to the actual machine of the control target 900 and time-series data of input values to the control target 900 to have the control target 900 output those envisaged values is generated. This combination of data is also referred to as operation plan data.

In the operation plan data, an input value and envisaged value are shown for each step in the time step. A step in a time step is also referred to as time in time step or simply time.

The input value at each time may be a scalar or a vector. In other words, the number of input items for the control target 900 may be one or more. The time-specific envisaged value may be a scalar or a vector. In other words, the number of output items from the control target 900 may be one or more.

The input value to the control target 900 in the operation plan data is also referred to as a planned input value. The planned input value is also denoted as a planned SV (set value). The envisaged value of the output of the control target 900 in the operation plan data is also referred to as a plan output value. The planned output value is also denoted as the planned PV (Process Value).

The method of creating operation plan data is not limited to any particular method.

For example, the simulator unit 182 may repeat the simulation of the control target 900 on a trial basis according to the operations of the person in charge of managing the control target 900. The combination of the time-series data of the input values to the simulation model and the time-series data of the output values of the simulation model in the simulation in which the output values desired by the person in charge were obtained may be stored by the storage unit 170 as operation plan data.

Alternatively, the person in charge of managing the control target 900 may use data of the actual machine as the operation plan data, for example, by selecting actual operation performance data showing desired output values from the actual operation performance data of the actual machine of the control target 900 and using it as the operation plan data.

Alternatively, the person in charge of managing the control target 900 may analyze the characteristics of the control target 900 and calculate a time series of desired output values and a time series of input values to obtain that time series for use as operation plan data.

During operation of the control device 200, it is conceivable that the characteristics of the control target 900 may differ from the characteristics at the time the operation plan data was created due to, for example, changes in weather conditions. The operation time of the control device 200 here is when the control device 200 controls the actual machine of the control target 900.

If the characteristics of the control target 900 differ from those at the time the operation plan data was created when the control device 200 is in operation, it is possible that the control device 200 may not obtain output values similar to the planned output values even if the planned input values are input directly to actual machine of the control target 900.

Therefore, the control device 200 corrects the input values to the actual machine from the planned input values so that the output values of the actual machine of the control target 900 are closer to the planned output values. As noted above, approaching here includes matching. In other words, the output value of the actual machine may match the planned output value.

In order to correspond to state changes during operation of the actual machine of the control target 900, the control device 200 calculates the parameter values of the correction algorithm, such as correction coefficients, at each time in the time step. The following is an example of a case in which the control device 200 uses a Finite Impulse Response (FIR) filter to correct the input values to the actual machine. The control device 200 generates a finite impulse response filter at each time and for each input item.

The control device 200 reads out the number of planned input values in the time series data of the planned input values corresponding to the order of the finite impulse response filter, going back in time from the planned input value at the time corresponding to the current time. The control device 200 then applies the finite impulse response filter to the readout planned input values. Specifically, the control device 200 performs convolution operations between the readout planned input values and the elements (filter coefficients) of the finite impulse response filter. In this way, the control device 200 calculates the input value to the control target 900 at each time and for each input item.

The application of a finite impulse response filter to the readout planned input values by the control device 200 is an example of correcting the planned input values. An input value calculated by the control device 200 by applying a finite impulse response filter to the readout planned input value corresponds to an example of an input value obtained by correcting the planned input value. An input value obtained by correcting the planned input value is also referred to as a corrected input value. The corrected input value is also denoted as a corrected SV.

Thus, the control device 200 corrects the planned input value using a finite impulse response filter. This allows the control device 200 to use not only the planned input value for the time corresponding to the current time, but also the planned input value for the time corresponding to a past time to correct the input value to the control target 900. Thereby, the control device 200 can reflect the state of the actual machine, which changes according to the past input values, in the correction. According to the control device 200, the input values can be corrected with high precision in this respect, and the output values of the actual machine can be brought closer to the planned output values.

The user of the control device 200, such as the person in charge of managing the control target 900, can interpret the correction policy by referring to the finite impulse response filter. The user can also refer to the finite impulse response filter to see whether the correction is appropriate.

However, the correction method used by the control device 200 to correct the planned input values is not limited to any particular method.

The control device 200 learns how to correct the input values to the actual machine. For example, the control device 200 reads the planned input values from the operation plan data, corrects them, and inputs the corrected input values to the simulator of the control target 900. The control device 200 then compares the output values of the simulator with the planned output values and updates the parameter values of the learning model based on the comparison results.

When correcting the planned input values using a finite impulse response filter as described above, the control device 200 may use as a learning model a model that receives inputs including the operation plan data, the input values to the simulator, and the output values of the simulator as learning data and outputs a finite impulse response filter. In this case, the parameters of the calculation formula for calculating the filter coefficient values from the input data values can be treated as the parameters to be learned.

During the learning process, similar to during operation, the control device 200 generates a finite impulse response filter for each time in a time step and for each input item.

During learning, the control device 200 inputs the operation plan data, historical data of corrected input values, and historical data of simulator output values for the corrected input values into the learned learning model to calculate the finite impulse response filter.

During operation, the control device 200 inputs the operation plan data, historical data of corrected input values, and historical data of output values of the actual machine for the corrected input values into the pre-trained learning model to calculate the finite impulse response filter.

Similar to during operation, during the learning process, the control device 200 reads out the number of planned input values in the time series data of the planned input values for the order of the finite impulse response filter, starting from the planned input value at the time corresponding to the current time in the simulation and going back in the past. The control device 200 then applies the finite impulse response filter to the readout planned input values. Specifically, the control device 200 performs convolution operations between the readout planned input values and the elements (filter coefficients) of the finite impulse response filter. In this way, the control device 200 calculates the corrected input values, which are the input values of the simulator of the control target 900s, at each time and for each input item.

The control device 200 inputs the corrected input values to the simulator of the control target 900, simulates the control target 900 for just one step in the time step, and calculates the output values of the simulator for the corrected input values.

When simulating the control target 900, the control device 200 changes the parameter values of the simulation model. This changing of parameter values corresponds to a simulation of a change in the state of the control target 900. By changing the parameter values of the simulation model, the control device 200 causes the learning model to learn a finite impulse response filter generation method to bring the output value of the control target 900 closer to the envisaged value when the state of the control target 900 changes.

A reinforcement learning algorithm can be used as the learning algorithm by which the control device 200 learns how to correct the input values to the control target 900.

For example, as the reward function, a reward function may be used in which the smaller the magnitude of the difference between the simulator output value and the envisaged value, the larger the reward value. The above learning model may then be treated as a policy function.

In this case, among the functions of the control device 200, the functions of generating a finite impulse response filter using the learning model and updating the parameter values of the learning model correspond to examples of agents. The simulator of the control target 900 corresponds to an example of the environment. The function of calculating corrected input values using a finite impulse response filter may be included in the agent or in the environment.

The generation of a finite impulse response filter or the calculation of corrected input values also correspond to examples of actions. The operation plan data, historical data of corrected input values, and historical data of simulator output values for corrected input values, which are input to the learning model, correspond to examples of state information to be acquired by the agent.

The control unit 280 controls each unit of the control device 200 to perform various processes. The functions of the control unit 280 are performed, for example, by the CPU included in the control device 200 reading and executing a program from storage unit 170.

The response trend calculation unit 281 calculates information indicating the trend of the response of the control target 900 by simulating the control target 900.

During learning of the control device 200, the response trend calculation unit 281 calculates the corrected output values output by the simulator, which is set to a state different from the state of the control target 900 assumed when setting the planned output values according to the planned input values, with respect to the corrected input values for which the planned input values to the control target 900 have been corrected. The corrected output value is the output value of the actual machine or simulator of the control target 900 for the input of the corrected input value.

The response trend calculation unit 281 corresponds to an example of a response trend calculation means.

The parameter value variation unit 282 changes the parameter values of the simulation model of the control target 900 by the simulator unit 182 during the training of the control device 200. The parameter value variation unit 282 changes the parameter values of the simulation model so that the state of the simulation model of the control target 900 is different from the state of the control target 900 envisaged when the operation plan data was created.

For example, the parameter value variation unit 282 uses random numbers to add noise to the parameter values. When there are multiple parameters in the simulation model of the control target 900, the parameter value variation unit 282 may select a parameter to which noise has been added, or may add noise to all parameter values.

The input value calculation unit 283 uses the planned input value, the planned output value, the corrected input value, and the corrected output value to learn a correction method for the planned input value. Then, the input value calculation unit 283 calculates the corrected input value by correcting the planned input value using the correction method to be learned.

The input value calculation unit 283 corresponds to an example of an input value calculation means.

The reinforcement learning unit 291 uses the planned input value, the planned output value, the corrected input value, and the corrected output value to learn a correction method for the planned input value. Specifically, the reinforcement learning unit 291 performs the learning described above for the control device 200. As described above for the control device 200, a reinforcement learning algorithm can be used as the learning algorithm by which the reinforcement learning unit 291 learns the correction method for the planned input value.

The reward calculation unit 292 calculates the reward (reward value) for the reinforcement learning unit 291 to learn the correction method for the planned input value. As described above for the control device 200, the reward calculation unit 292 may calculate the reward using a reward function where the smaller the magnitude of the difference between the output value of the simulator and its envisaged value, the larger the reward value.

The correction coefficient calculation unit 293 calculates a correction coefficient for correcting the planned input value. As described above for the control device 200, the correction coefficient calculation unit 293 may calculate a finite impulse response filter as the correction coefficient.

The correction calculation unit 284 performs corrections to the planned input value using the correction coefficient calculated by the correction coefficient calculation unit 293. As described above for the control device 200, when the correction coefficient calculation unit 293 calculates the finite impulse response filter, the correction calculation unit 284 reads out the number of planned input values in the time series data of the planned input values corresponding to the order of the finite impulse response filter, going back in time from the planned input value at the time corresponding to the current time. The correction calculation unit 284 then applies a finite impulse response filter to the readout planned input values. Specifically, the correction calculation unit 284 performs a convolution operation between the readout planned input values and the element (filter coefficient) of the finite impulse response filter. In this way, the correction calculation unit 284 calculates the input value to the control target 900 at each time and for each input item.

Among the time-series data of planned input values, the number of planned input values used by the correction coefficient calculation unit 293 should be one or more. Therefore, the correction coefficient calculation unit 293 may read only one planned input value from the time series data of planned input values for each one step in the time step.

The planned output value used by the correction coefficient calculation unit 293 out of the time series data of the planned output values can be the planned output value corresponding to the same time as the planned input value used by the correction coefficient calculation unit 293 out of the time-series data of the planned input values. Therefore, the number of planned output values used by the correction coefficient calculation unit 293 out of the time series data of planned output values can be the same as the number of planned input values used by the correction coefficient calculation unit 293 among the time-series data of planned input values.

Of the historical data of actual input values, the number of actual input values used by the correction coefficient calculation unit 293 should be one or more. Therefore, the correction coefficient calculation unit 293 may read only one actual input value out of the historical data of actual input values for each one step in the time step.

The actual output value used by the correction coefficient calculation unit 293 out of the historical data of actual output values can be the actual output value corresponding to the same time as the actual input value used by the correction coefficient calculation unit 293 out of the historical data of actual input values. Therefore, the number of actual output values used by the correction coefficient calculation unit 293 out of the historical data of actual output values can be the same as the number of actual input values used by the correction coefficient calculation unit 293 out of the time series data of actual input values.

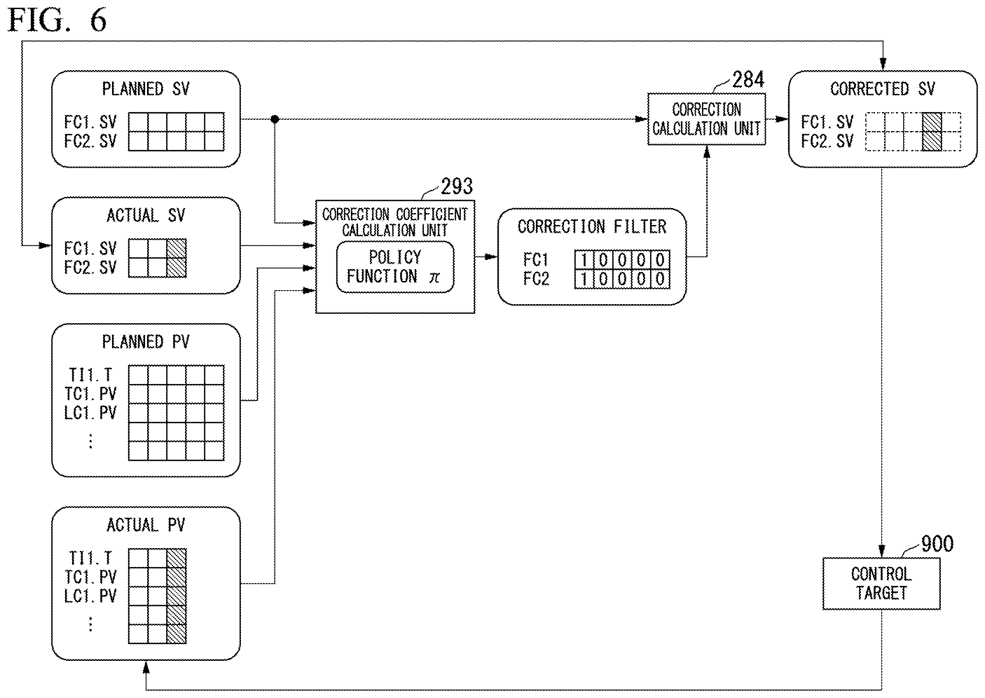

FIG. 6 is a diagram showing an example of data flow during operation of the control device 200.

In the example in FIG. 6, the correction coefficient calculation unit 293 inputs time-series data of planned input values, historical data of actual input values, time-series data of planned output values, and historical data of actual output values to the policy function η. Then, the correction coefficient calculation unit 293 calculates the correction coefficient for the planned input value in the form of a finite impulse response filter by calculating the output value of the policy function x. The filter calculated by the correction coefficient calculation unit 293 is also referred to as the correction filter.

The correction calculation unit 284 applies the correction filter to the time-series data of the planned input value. The correction calculation unit 284 then performs a correction to the planned input value and calculates the corrected input value.

The correction coefficient calculation unit 293 uses the corrected input value as the actual input value.

The communication unit 110 of the control device 200 transmits the corrected input value to the actual device of the control target 900. The control device 200 controls the control target 900 by causing the control target 900 to operate based on the corrected input value.

The control target 900 includes various sensors to acquire various pieces of data, including the state quantity of the control target 900 itself and the state quantity of the surrounding environment, and transmits the obtained data to the control device 200.

In the control device 200, the communication unit 110 receives the data from the control target 900. The correction coefficient calculation unit 293 uses the data from the control target 900 as the actual output value.

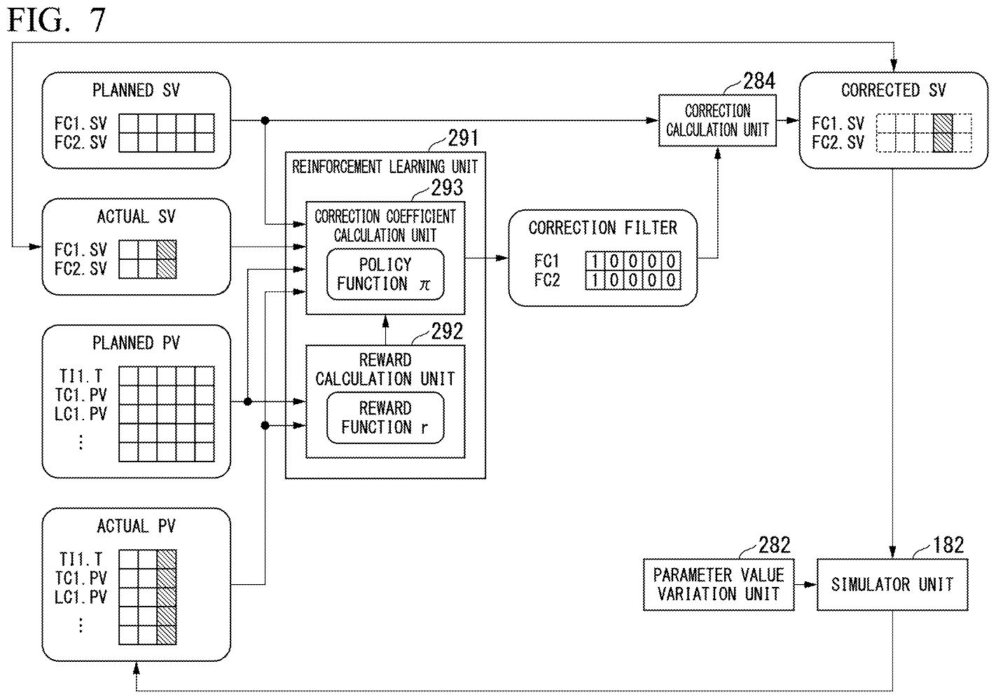

FIG. 7 shows an example of data flow during training of the control device 200.

As in FIG. 6, in the example in FIG. 7, the correction coefficient calculation unit 293 inputs time series data of planned input values, historical data of actual input values, time series data of planned output values, and historical data of actual output values to the policy function π. Then, the correction coefficient calculation unit 293 calculates the correction coefficient for the planned input value in the form of a finite impulse response filter by calculating the output value of the policy function π. As mentioned above, the filter calculated by the correction coefficient calculation unit 293 is also referred to as the correction filter.

As in the case of FIG. 6, in the example in FIG. 7, the correction calculation unit 284 applies the correction filter to the time-series data of the planned input value. The correction calculation unit 284 then performs a correction to the planned input value and calculates the corrected input value.

The correction coefficient calculation unit 293 uses the corrected input value as the actual input value.

In the example in FIG. 7, the correction calculation unit 284 inputs the corrected input value that was calculated to the simulation model of the control target 900 by the simulator unit 182.

In the example in FIG. 7, the parameter value variation unit 282 changes the parameter values of the simulation model of the control target 900. As described above, the parameter value variation unit 282 changes the parameter values so that the state of the simulation model of the control target 900 is different from the state of the control target 900 envisaged when the operation plan data was created.

The simulator unit 182 executes a simulation of the control target 900 and calculates the output value of the simulation model with respect to the input of the corrected input value. This output value corresponds to the corrected output value.

The correction coefficient calculation unit 293 uses the corrected output value calculated by the simulator unit 182 as the actual output value.

In the example in FIG. 7, the reinforcement learning unit 291 learns a correction method for the planned input value.

The reward calculation unit 292 calculates the reward value by inputting the actual output value and the planned output value into the reward function r. The reward calculation unit 292 uses a reward function r where the smaller the magnitude of the difference between the actual output value and the planned output value, the larger the reward value.

The correction coefficient calculation unit 293 updates the learning parameter values of the policy function x based on the time-series data of the planned input values, the historical data of the actual input values, the time-series data of the planned output values, the historical data of the actual output values, and the reward calculated by the reward calculation unit 292. In this way, the reinforcement learning unit 291 learns the calculation method of the correction filter so that the actual output value approaches the planned output value.

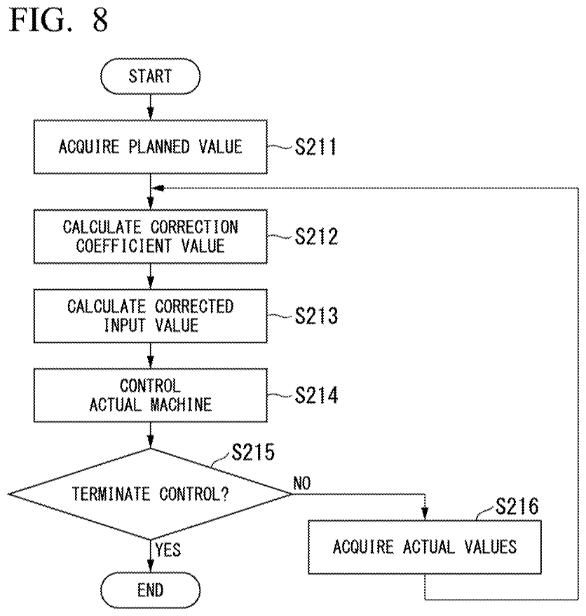

FIG. 8 is a flowchart showing an example of the processing steps that the control device 200 performs during operation.

In the process shown in FIG. 8, the control device 200 obtains the operation plan data (Step S211). For example, the storage unit 170 may store the operation plan data in advance, and the control unit 280 may read the operation plan data from the storage unit 170.

Next, the correction coefficient calculation unit 293 calculates the correction coefficient for correcting the input value to the actual machine of the control target 900 (Step S212). The correction coefficient calculation unit 293 may generate a finite impulse response filter as a correction coefficient.

Next, the correction calculation unit 284 calculates the corrected input value by correcting the planned input value using the correction coefficient calculated by the correction coefficient calculation unit 293 (Step S213).

The correction calculation unit 284 controls the actual machine by transmitting a control command including the corrected input value that was calculated to the actual machine via the communication unit 110 (Step S214).

Next, the control unit 280 determines whether or not to terminate the control of the actual machine (Step S215). For example, the control unit 280 may determine to terminate control of the actual machine when control of the actual machine based on the operation plan data has been completely performed, i.e., when control of the actual machine has been performed for the number of time steps in the operation plan data.

If it is determined that control of the actual machine is to continue (Step S215: NO), the control unit 280 acquires the actual values of input/output in the actual machine (Step S216). Specifically, the control unit 280 uses the corrected input value calculated by correction calculation unit 284 in Step S213 as the actual input value to the actual machine. The control unit 280 uses the output value of the actual machine received by the communication unit 110 as the actual output value of the actual machine.

After Step S216, the process returns to Step S212. In this case, the control device 200 continues to control the actual machine.

On the other hand, if the control unit 280 determines in Step S215 to end the control of the actual machine (Step S215: YES), the control device 200 completes the end in FIG. 8.

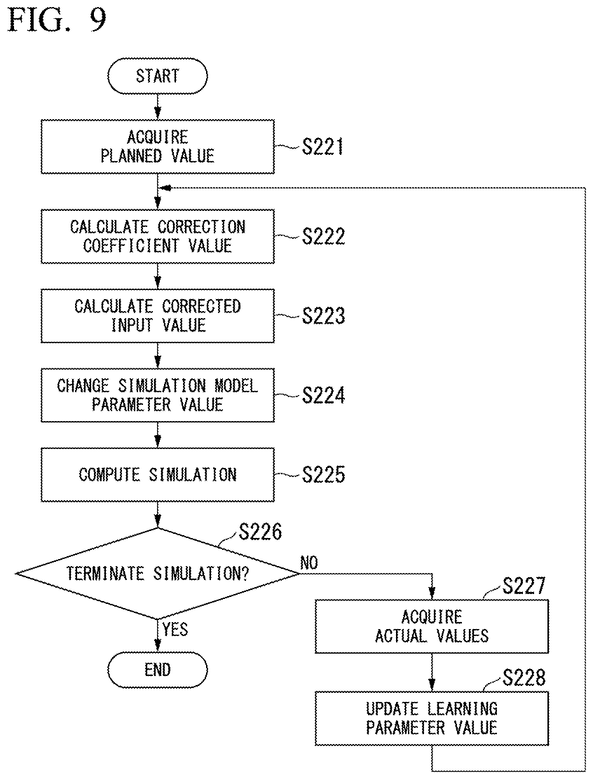

FIG. 9 is a flowchart showing an example of the processing procedure that the control device 200 performs during learning.

The process in steps S221 through S223 in FIG. 9 is similar to the process in steps S211 through S213 in FIG. 8.

After Step S223, the parameter value variation unit 282 changes the parameter values of the simulation model of the control target 900 (Step S224).

Next, the simulator unit 182 uses the changed parameter values to compute the simulation of the control target 900 for one step in the time step (Step S225).

Next, the control unit 280 determines whether to terminate the simulation of the control target 900 (Step S226). For example, the control unit 280 may determine that the simulation is completed when all simulations based on the operation plan data have been performed, i.e., when simulation of the control target 900 has been performed for the number of time steps in the operation plan data.

Upon determining that the simulation is to continue (Step S226: NO), the control unit 280 acquires the input/output values to the simulation model as actual values (Step S227). Specifically, control unit 280 uses the corrected input value calculated by correction calculation unit 284 in Step S223 as the actual input value to the simulator. The control unit 280 also uses the output value of the simulator as the actual output value of the simulator.

Next, the reinforcement learning unit 291 learns the input value to the control target 900 based on a comparison of the actual output value and the planned output value, and updates the learning parameter value (Step S228).

After Step S228, the process returns to Step S222. In this case, the control device 200 continues the simulation of the control target 900 and learning using the simulation results.

On the other hand, if the control unit 280 makes a determination to end the simulation in Step S226 (Step S226: YES), the control device 200 ends the process in FIG. 9.

As described above, the response trend calculation unit 281 calculates the corrected output values output by the simulator, which is set to a state different from the state of the control target 900 assumed when the planned output values were set according to the planned input values, for the corrected input values that is obtained by correcting the planed input value to the control target 900. The input value calculation unit 283 uses the planned input value, the planned output value, the corrected input value, and the corrected output value to learn a correction method for the planned input value. The input value calculation unit 283 calculates the corrected input value by correcting the planned input value using the correction method to be learned.

According to the control device 200, if the envisaged value of the output cannot be obtained by inputting the predetermined input value to the control target 900, such as when the characteristics of the control target 900 differ between the operation planning phase and the actual operation phase, it is possible to bring the output value of the control target 900 closer to the envisaged value without the need to analyze the state of the control target 900.

In particular, the control device 200 calculates information indicating the trend in the response of the control target 900 through simulation. This allows the control device 200 to ascertain the response trend without affecting the operation of the actual machine of the control target 900.

The input value calculation unit 283 performs a correction to the planned input value by applying a finite impulse response filter to the time-series data of the planned input value.

This allows the control device 200 to use not only the planned input value for the time corresponding to the current time, but also the planned input value for the time corresponding to a past time to correct the input value to the control target 900. Thereby, the control device 200 can reflect the state of the actual machine, which changes according to the past input values, in the correction. According to the control device 200, the input values can be corrected with high precision in this respect, and the output values of the actual machine can be brought closer to the planned output values.

The user of the control device 200, such as the person in charge of managing the control target 900, can interpret the correction policy by referring to the finite impulse response filter. The user can also refer to the finite impulse response filter to see whether the correction is appropriate.

### Third Example Embodiment

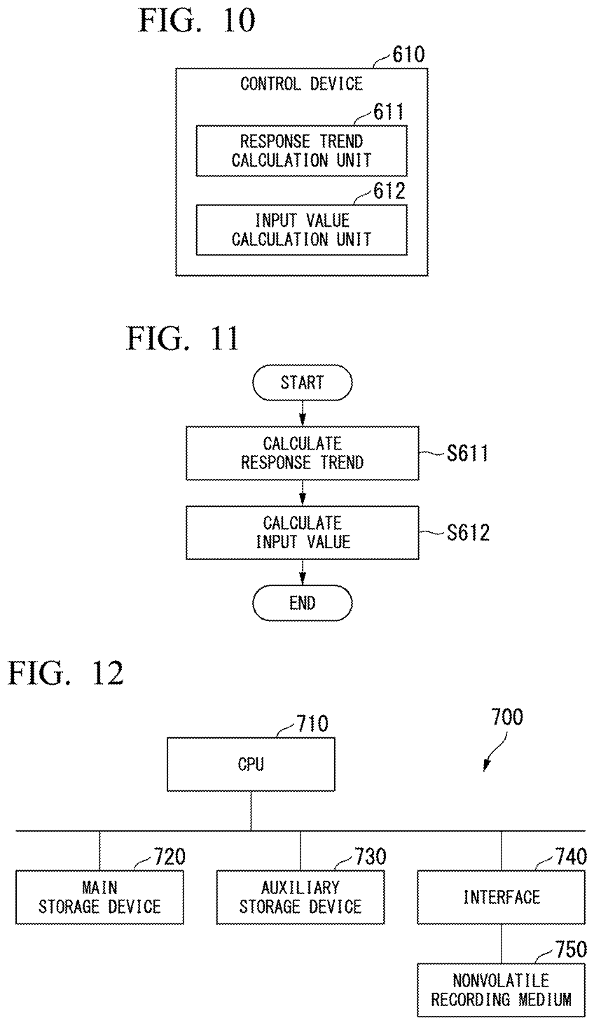

FIG. 10 is a diagram illustrating an example configuration of the control device according to the third example embodiment. In the configuration shown in FIG. 10, the control device 610 includes a response trend calculation unit 611 and an input value calculation unit 612.

In such a configuration, the response trend calculation unit 611 calculates, by simulation of the control target, information indicating the trend in the response of the control target. The input value calculation unit 612 calculates, on the basis of the information indicating a trend in the response of the control target, an input value to the control target in order to bring the output value of the control target closer to the envisaged value.

The response trend calculation unit 611 corresponds to an example of a response trend calculation means. The input value calculation unit 612 corresponds to an example of an input value calculation means. envisaged value.

According to the control device 610, if the envisaged value of the output cannot be obtained by inputting the predetermined input value to the control target, such as when the characteristics of the control target differ between the operation planning phase and the actual operation phase, it is possible to bring the output value of the control target closer to the envisaged value without the need to analyze the state of the control target.

In particular, the control device 610 calculates information indicating the trend in the response of the control target through simulation. This allows the control device 610 to ascertain the response trend without affecting the operation of the actual machine of the control target.

The response trend calculation unit 611 can be realized using, for example, functions such as the response trend calculation unit 181 shown in FIG. 1. The input value calculation unit 612 can be realized using, for example, functions such as the input value calculation unit 183 shown in FIG. 1.

The response trend calculation unit 611 can be realized using, for example, functions such as the response trend calculation unit 281 shown in FIG. 5. The input value calculation unit 612 can be realized using, for example, functions such as the input value calculation unit 283 shown in FIG. 5.

### Fourth Example Embodiment

FIG. 11 is a flowchart showing an example of the processing procedure in the control method for the fourth example embodiment. The control method shown in FIG. 11 includes calculating the response trend (Step S611) and the input value (Step S612).

In calculating the response trend (Step S611), information indicating the response trend of the control target is calculated by simulation of the control target.

In calculating an input value (Step S612), an input value to the control target in order to bring the output value of the control target closer to the envisaged value is calculated on the basis of the information indicating a trend in the response of the control target.

According to the control method shown in FIG. 11, if the envisaged value of the output cannot be obtained by inputting the predetermined input value to the control target, such as when the characteristics of the control target differ between the operation planning phase and the actual operation phase, it is possible to bring the output value of the control target closer to the envisaged value without the need to analyze the state of the control target.

In particular, the control method shown in FIG. 11 uses simulation to calculate information indicating a trend in the response of the control target. This allows the control method shown in FIG. 11 to ascertain the response trend without affecting the operation of the actual machine of the control target.

FIG. 12 is a schematic block diagram illustrating the configuration of a computer according to at least one example embodiment.

In the configuration shown in FIG. 12, a computer 700 includes a CPU 710, a main storage device 720, an auxiliary storage device 730, an interface 740, and a nonvolatile recording medium 750.

Any one or more of the aforementioned control device 100, control device 200, and control device 610, or any part thereof, may be implemented in the computer 700. In that case, the operations of each of the above-mentioned processing units are stored in the auxiliary storage device 730 in the form of a program. The CPU 710 reads the program from the auxiliary storage device 730, loads the program in the main storage device 720, and executes the above processing according to the program. The CPU 710 also reserves a memory area in the main storage device 720 corresponding to each of the above-mentioned storage units according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

When the control device 100 is implemented in the computer 700, the operation of the control unit 180 and each part thereof is stored in the auxiliary storage device 730 in the form of a program. The CPU 710 reads the program from the auxiliary storage device 730, loads the program in the main storage device 720, and executes the above processing according to the program.

The CPU 710 also reserves a memory area in the main storage device 720 corresponding to the storage unit 170 according to the program.

Communication with other devices by the communication unit 110 is performed by the interface 740, which has a communication function and operates according to the control of the CPU 710.

The display by the display unit 120 is performed by the interface 740 having a display device and displaying various images according to the control of the CPU 710.

Reception of user operations by the operation input unit 130 is performed by the interface 740 having input devices such as a keyboard and a mouse, for example, to receive user operations and outputting information indicating received user operations to the CPU 710.

When the control device 200 is implemented in the computer 700, the operation of the control unit 180 and each part thereof is stored in the auxiliary storage device 730 in the form of a program. The CPU 710 reads the program from the auxiliary storage device 730, loads the program in the main storage device 720, and executes the above processing according to the program.

The CPU 710 also reserves a memory area in the main storage device 720 corresponding to the storage unit 170 according to the program.

Communication with other devices by the communication unit 110 is performed by the interface 740, which has a communication function and operates according to the control of the CPU 710.

The display by the display unit 120 is performed by the interface 740 having a display device and displaying various images according to the control of the CPU 710.

Reception of user operations by the operation input unit 130 is performed by the interface 740 having input devices such as a keyboard and a mouse, for example, to receive user operations and outputting information indicating received user operations to the CPU 710.

When the control device 610 is implemented in the computer 700, the operations of the response trend calculation unit 611 and the input value calculation unit 612 are stored in the auxiliary storage device 730 in the form of a program. The CPU 710 reads the program from the auxiliary storage device 730, loads the program in the main storage device 720, and executes the above processing according to the program.

The CPU 710 also reserves a memory area in the main storage device 720 for the processing performed by the control device 610 according to the program.

Communication between the control device 610 and other devices is performed by the interface 740, which has a communication function and operates according to the control of the CPU 710.

Interaction between the control device 610 and the user is performed by the interface 740 having input and output devices, presenting information to the user with the output devices and receiving user operations with the input devices according to the control of the CPU 710.

Any one or more of the programs described above may be recorded on the nonvolatile recording medium 750. In this case, the interface 740 may read the program from the nonvolatile recording medium 750. The CPU 710 may then directly execute the program read by the interface 740, or the program may be stored once in the main storage device 720 or the auxiliary storage device 730 and then executed.

A program for executing all or part of the processing performed by the control device 100, control device 200, and control device 610 may be recorded on a computer-readable recording medium, and the computer system, by reading and executing the program recorded on this recording medium, may perform the processing of each part. The term “computer system” here shall include hardware such as an operating system and peripherals.

In addition, “computer-readable recording medium” means a portable medium such as a flexible disk, magneto-optical disk, ROM (Read Only Memory), CD-ROM (Compact Disc Read Only Memory), or a storage device such as a hard disk built into a computer system. The above program may be used to realize some of the aforementioned functions, and may also be used to realize the aforementioned functions in combination with programs already recorded in the computer system.

Although the above example embodiments of this invention have been described in detail with reference to the drawings, specific configurations are not limited to these example embodiments, with designs and the like within the range not departing from the gist of this invention also included.

### INDUSTRIAL APPLICABILITY

Example embodiments of the present invention may be applied to a control device, a control method, and a recording medium.

### DESCRIPTION OF REFERENCE SYMBOLS

1, 2 Control system
100, 200, 610 Control device
110 Communication unit
120 Display unit
130 Operation input unit
170 Storage unit
180, 280 Control unit
181, 281, 611 Response trend calculation unit
182 Simulator unit
183, 283, 612 Input value calculation unit
282 Parameter value variation unit
291 Reinforcement learning unit
292 Reward calculation unit
293 Correction coefficient calculation unit
284 Correction calculation unit

What is claimed is:

1. A control device comprising:
a memory configured to store instructions; and
a processor configured to execute the instructions to:
calculate, by simulation of a control target, information indicating a trend of response of the control target; and
calculate, based on the information indicating the trend of the response of the control target, an input value to the control target in order to bring an output value of the control target closer to an envisaged value.

2. The control device according to claim 1,
wherein the processor is configured to execute the instructions to calculate a ratio of a change amount in an output value of the simulator of the control target with respect to a change amount in an input value to the simulator, and
the processor is configured to execute the instructions to calculate the input value to the control target, based on a difference between the output value of the control target and the envisaged value, and the ratio.

3. The control device according to claim 1,
wherein the processor is configured to execute the instructions to calculate, for each input item to the control target, a ratio of a change mount in an output value of the simulator of the control target with respect to a change amount in an input value, and
the processor is configured to execute the instructions to calculate the input value to the control target, based on a difference between the output value of the control target and the envisaged value, and the ratio.

4. The control device according to claim 1,
wherein the processor is configured to execute the instructions to calculate, for each input item to the control target and for each output item of the control target, a ratio of a change amount in an output value of the simulator of the control target with respect to a change amount in an input value, and
the processor is configured to execute the instructions to calculate a provisional input value for each output item, based on a difference between the output value of the control target and the envisaged value and the ratio, and calculate the input value to the control target based on the provisional input value.

5. The control device according to claim 1,
wherein the processor is configured to execute the instructions to calculate a ratio of a change amount in an output value of the simulator of the control target with respect to a change amount in an input value to the simulator, and
the processor is configured to execute the instructions to calculate the input value to the control target based on a difference between the output value of the control target and the envisaged value, and a value obtained by converting the ratio based on a difference between the output value of the control target and the envisaged value.

6. The control device according to claim 1,
wherein the processor is configured to execute the instructions to calculate, for a corrected input value obtained by correcting a planned input value to the control target, a corrected output value output by the simulator that is set to a state different from a state of the control target envisaged at time of setting a planned output value corresponding to the planned input value, and
the processor is configured to execute the instructions to learn a correction method for the planned input value by using the planned input value, the planned output value, the corrected input value, and the corrected output value, and calculate the corrected input value by correcting the planned input value using the correction method.

7. The control device according to claim 6, wherein the processor is configured to execute the instructions to correct the planned input value by applying a finite impulse response filter to time-series data of the planned input value.

8. A control method executed by a computer, comprising:
calculating, by simulation of a control target, information indicating a trend of response of the control target; and
calculating, based on the information indicating the trend of the response of the control target, an input value to the control target in order to bring an output value of the control target closer to an envisaged value.

9. A non-transitory recording medium that records a program for causing a computer to execute
calculating, by simulation of a control target, information indicating a trend of the response of the control target; and
calculating, based on the information indicating the trend of the response of the control target, an input value to the control target in order to bring an output value of the control target closer to an envisaged value.
